(19) United States
(12) Patent Application Publication
(10) Pub. No.: US 2025/0244458 A1
(43) Pub. Date: Jul. 31, 2025

(54) JAMMING AS A BISTATIC RADAR SOURCE

(71) Applicant: BAE SYSTEMS Information and Electronic Systems Integration Inc., Nashua, NH (US)

(72) Inventor: Michael H. Stockmaster, Cedar Rapids, IA (US)

(73) Assignee: BAE SYSTEMS Information and Electronic Systems Integration Inc., Nashua, NH (US)

(21) Appl. No.: 18/365,509

(22) Filed: Aug. 4, 2023

(51) Int. Cl. G01S 13/00; G01S 7/36; G01S 13/42; G01S 13/90

(52) U.S. Cl. CPC G01S 13/003; G01S 7/36; G01S 13/42; G01S 13/9058

(57) ABSTRACT

In one example, a bistatic radar receiver includes at least one first antenna configured to receive one or more jamming signals, a second antenna configured to point a scanning beam to detect one or more reflections of the one or more jamming signals from a target, and a signal processing subsystem coupled to the at least one first antenna and to the second antenna, the signal processing subsystem configured to process the one or more jamming signals and the one or more reflections to derive a range to the target from the one or more jamming signals and the one or more reflections.

### BACKGROUND

A bistatic radar is a type of passive ranging system that allows a user to locate a target without the transmission of electromagnetic energy that can give away the user's position, because the radar transmitter is distanced from the radar receiver. In contrast, the transmitter and receiver of a monostatic radar are co-located. Global positioning system (GPS) satellite transmissions can be used for a bistatic radar. However, GPS-based bistatic radar systems suffer from a number of drawbacks.

### SUMMARY

Aspects and embodiments are directed to bistatic radar systems and techniques for using anti-jam receivers to implement target ranging based on bistatic radar principles.

According to one embodiment a bistatic radar receiver comprises at least one first antenna configured to receive one or more jamming signals, a second antenna configured to point a scanning beam to detect one or more reflections of the one or more jamming signals from a target, and a signal processing subsystem coupled to the at least one first antenna and to the second antenna, the signal processing subsystem configured to process the one or more jamming signals and the one or more reflections to derive a range to the target from the one or more jamming signals and the one or more reflections.

According to another embodiment, a bistatic radar method comprises acquiring at least one jamming signal emitted by a jammer, pointing a scanning beam to acquire at least one reflection of the jamming signal from a target, determining an angle of arrival of the jamming signal, determining a correlation between a peak of the at least one jamming signal and a corresponding peak of the at least one reflection, and deriving a range to the target based on the angle of arrival of the jamming signal, the correlation, and a pointing angle of the scanning beam.

Another embodiment is directed to a passive ranging apparatus comprising an antenna module including a first antenna configured to receive a jamming signal emitted by a jammer, and a second antenna configured to point a scanning beam, at least one processor, and at least one tangible non-transitory computer-readable storage medium. The at least one tangible non-transitory computer-readable storage medium stores program instructions that when executed by the at least one processor configure the passive ranging apparatus to point the scanning beam to acquire a reflection of the jamming signal from a target, determine an angle of arrival of the jamming signal at the first antenna, and derive a range to the target based on the jamming signal, the reflection, the angle of arrival, and a pointing angle of the scanning beam.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

In the figures:

FIG. 1 is a block diagram of an example of a bistatic radar system, in accord with aspects of the present disclosure;

FIG. 2 is an example depiction of the geometry used in a bistatic radar solution, according to aspects of the present disclosure; and

FIG. 3 is a block diagram of an example of a receiver configured to implement bistatic radar processing, according to aspects of the present disclosure;

FIG. 4 is a flow diagram one example of a signal processing method including bistatic radar processing, in accord with aspects of the present disclosure; and

FIG. 5 is a block diagram of one example of a computing platform, in accord with aspects of the disclosed technology.

### DETAILED DESCRIPTION

Techniques are disclosed for bistatic radar systems. The techniques can be used in any number of applications such as, for instance, for adding bistatic radar and imaging capabilities to electronic sensor systems, such as those implementing anti-jamming signal processing.

According to certain examples, a bistatic radar receiver includes at least one first antenna configured to receive one or more jamming signals, and a second antenna configured to point a scanning beam to detect one or more reflections of the one or more jamming signals from a target. A signal processing subsystem coupled to the at least one first antenna and to the second antenna can be configured to process the one or more jamming signals and the one or more reflections to derive a range to the target from the one or more jamming signals and the one or more reflections. In some examples, the bistatic radar receiver can be implemented in an anti-jam receiver, which may then operate as a combined anti-jam receiver and bistatic radar receiver, Thus, jamming signals that the anti-jam receiver is configured to mitigate can be used to implement bistatic radar functionality. In some examples, the anti-jam receiver can include GNSS based navigation functionality. Accordingly, examples of the systems and methods disclosed herein can be used in conjunction with GNSS based bistatic radar processing in some instances.

### General Overview

As noted above, GPS satellite transmissions can be used for a bistatic radar, but such GPS-based bistatic radar systems suffer from a number of drawbacks. In more detail, a bistatic radar system provides range to target information by detecting and processing transmitted signals from a source (such as a Global Navigation Satellite System (GNSS) satellite, for example). Generally, a bistatic radar system includes at least two receiver channels per target, one to track the direct signal from the source and one to track a signal from the same source that has been reflected off the target. While GNSS signals provide worldwide coverage, they are relatively weak. Signal processing can overcome some of the limitations but adds cost and complexity to the system. For example, because the GNSS signals are relatively weak and may be below the noise floor, a GNSS receiver offering correlation and/or tracking capability is used to extract the range information. However, due to the weak signals involved, GNSS based bistatic radar systems are still limited to tracking targets that at relatively close range and/or have fairly large radar cross-sections. Also, GPS-based bistatic radar systems are susceptible to reception of multi-path reflected signals and jamming issues.

Accordingly, techniques are provided for implementing a bistatic radar system. In an example, the bistatic radar system exploits the presence of higher powered signals to allow better long range capability as well as detection of lower radar cross-section (RCS) targets for ranging and/or imaging. In more detail, anti-jam systems are designed to operate in the presence of high-powered jamming signals. Accordingly, certain examples adapt anti-jam systems to allow the use of jammer signals as “signals of opportunity” for passive ranging. As described in more detail below, processing elements configured to provide direction finding (DF) and jammer characterization (JC) capabilities in an anti-jam receiver system can be leveraged to enable the use of jamming signals for bistatic radar without requiring hardware changes to the anti-jam receiver system. In addition, synthetic aperture radar (SAR) processing can be incorporated to add imaging capability, as described further below. Thus, improved situational awareness may be provided for users by adding target range information and SAR images to the target direction finding and jammer characterization features provided by the anti-jam receiver system. By processing the much higher-power jamming signals, rather than GNSS signals, examples provide ranging and imaging information for targets at extended ranges and/or with smaller radar cross-sections, thereby overcoming some limitations associated with GNSS-based bistatic radar systems.

### System Architecture

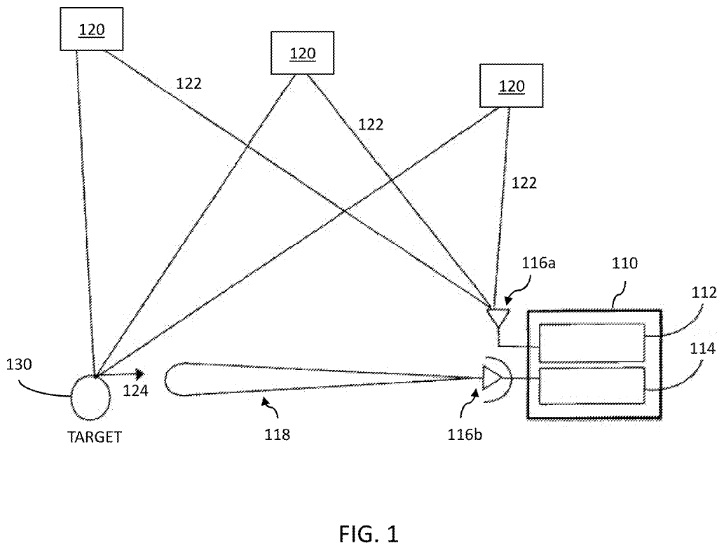

FIG. 1 is a block diagram of an example of a bistatic radar system. A bistatic radar receiver 110 receives transmissions from one or more sources 120. As described above, in examples, the receiver 110 includes two channels, namely a first channel 112 that receives direct signals 122 transmitted by the sources 120 and a second channel 114 that receives reflections 124 of the signals 122 that have been reflected off a target 130. Each channel 112, 114, may include an associated antenna 116a, 116b, respectively. The time difference in correlation peaks between signals processed on the two channels 122, 124 is related to the range from the receiver 110 to the target 130.

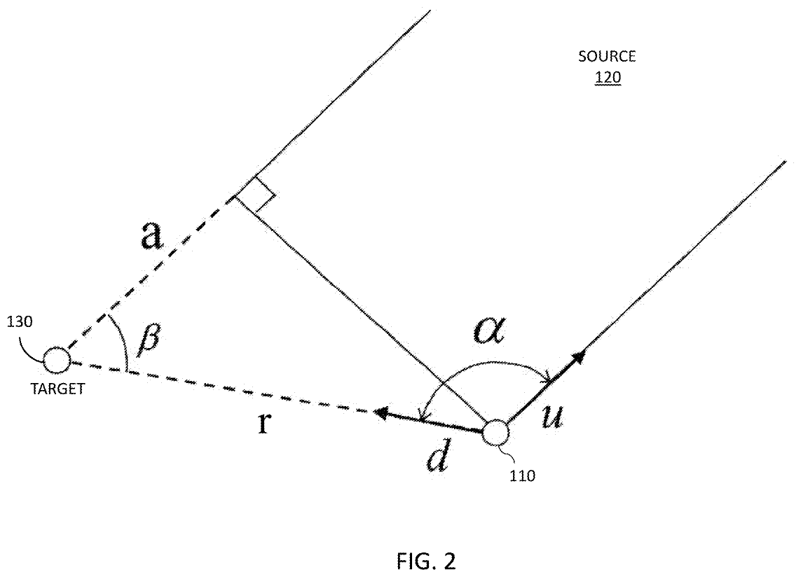

To find the range to the target 130, consider the FIG. 2. The measured time difference between the two channels 112, 114 is given by (a+r)/c where c is the speed of light. The difference in distance between the two channels is given by m=a+r. However, the distance of interest is r; the range to the target 130. In order to find r, the angle α must be known. This angle can be determined from two unit vectors: one from the observation point (the receiver 110) to the source 120 (u) and the other from the observation point to the target 130 (d). The angle α can be obtained from vectors u and d by solving the following equation for a:

$$cos α = u \cdot d \qquad ( 1 )$$

Once the angle α is obtained from Equation (1), the angle β can be found from Equation (2):

$$β = 90 - ( α - 90 ) = 180 - α \qquad ( 2 )$$

The relation between the distances a and r is given by Equation (3):

$$a = r cos β = - r cos α \qquad ( 3 )$$

Since m=a+r, the range r can be obtained from Equations (4) and (5):

$$m = a + r = r ( 1 - cos α ) \qquad ( 4 )$$

Equation (4) can be rewritten as Equation (5) to give r:

$$r = \frac{m}{1 - cos α} \qquad ( 5 )$$

The known position of the receiver 110, the range, r, to the target 130 obtained according to the above, and the known unit vector d from the receiver 110 to the target 130 can be used to determine the position of the target 130. These concepts can be applied in a GNSS based bistatic radar system, in which the sources 120 are GNSS satellites. However, as described above, GNSS based bistatic radar systems suffer from several drawbacks, including the need to be fairly close range to a reasonably-sized target, with weak reflections from targets with low scattering coefficients further limiting the range, as well as performance degradation due to jamming in the GNSS receiver. Examples of the techniques described herein overcome these drawbacks and provide for enhanced bistatic radar performance and improved situational awareness for the user, as described further below.

Referring again to FIG. 1, and with continuing reference to FIG. 2, according to certain embodiments, the bistatic radar receiver 110 is implemented using an anti-jam receiver that is configured to apply bistatic radar processing to high-power jamming signals 122 (emitted by jamming sources 120) that the anti-jam receiver is employed to mitigate. As described in more detail below, according to certain examples, angle of arrival information provided by direction finding processing implemented in the anti-jam receiver can be used to determine the unit vector u used above, and spatial isolation adaptive beamforming that is employed for jammer characterization can be used to collect the reflections 124 in the direction of a scanning beam 118. In some examples, beamforming provides directionality to better isolate both the direct 122 and reflected 124 signals, thereby improving the range and accuracy of the bistatic radar. In addition, adaptive nulling used for jammer filtering may also mitigate the impact of other jamming signals on the accuracy of the range measurements.

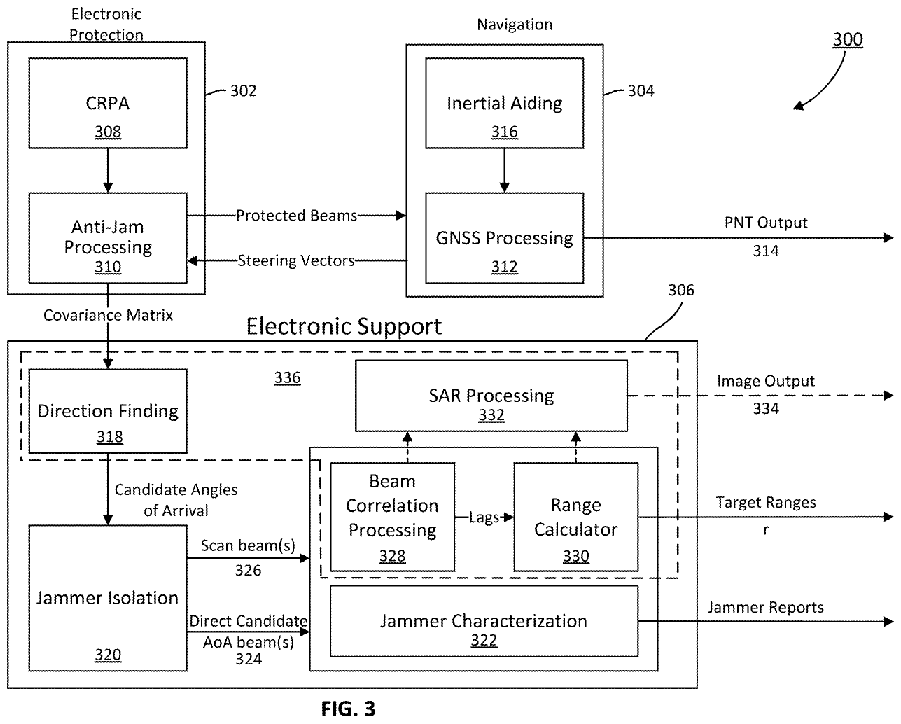

FIG. 3 is a block diagram of one example of an anti-jam receiver 300 that can be configured to operate as a bistatic radar and may be used as the bistatic radar receiver 110 in certain examples. In the illustrated example, the anti-jam receiver 300 includes functional subsystems for electronic protection 302, navigation 304, and electronic support 306. The subsystems 302, 304, 206 may be implemented in any functional instantiation of software, firmware, hardware, or any combination thereof. Further, any two or more of the functional subsystems 302, 304, 306 may be combined in implementation. Accordingly, the functional subsystems 302, 304, 306 are not necessarily intended to represent dedicated or discrete systems, but rather to represent functionality that may be implemented by the anti-jam receiver 300.

The anti-jam receiver 300 can be configured to provide dual functionality, both operating as a bistatic radar using the jamming signals 122 and operating to mitigate the effect of those jamming signals on the navigation subsystem 304. As described further below, in addition to providing the location and characteristics of the jamming signals 122 in view of the anti-jam receiver 300, examples can be used to identify the location and size of objects in the field of view. If there is relative motion between the anti-jam receiver 300 and jamming sources 120, target ranging can be extended to SAR and provide an image of the surrounding area. These capabilities can be implemented through software and/or firmware enhancements, without requiring hardware modifications to an existing anti-jam receiver architecture.

In certain examples, the anti-jam receiver 300 includes an antenna module 308 that includes two or more antennas (e.g., including the antennas 116a, 116b) used to receive the direct and reflected jamming signals 122, 124, respectively. The antenna module 308 may further include one or more antennas configured to receive GNSS signals to be used by the navigation subsystem 304. The antennas in the antenna module 308 may be adaptive antennas, null-steering antennas, beamforming antennas, or the like. In one example, the antennas are controlled reception pattern antennas (CRPAs), or other multi-element antennas. As described further below, in some examples, spatial adaptive processing can be used to control antenna beamforming and improve directionality for both the direct channel 112 and the reflected channel 114.

The GNSS and jamming signals received via the antenna module 308 are processed by anti-jam processing module 310 to produce one or more “protected” beams (e.g., GNSS signals) that are provided to the navigation subsystem 304, as shown. The anti-jam processing module 310 may include various filters and other electronics configured to implement spatial processing according to known techniques to filter or suppress the jamming signals 122 and recover signals of interest, such as GNSS navigation signals, for example.

The navigation subsystem 304 includes a GNSS processing module 312 configured to produce a navigational output 314 based on the protected beams received from the electronic protection subsystem 302. In some examples, the navigation subsystem 304 may also include an inertial aiding module 316 that can provide various measurements or information to the GNSS processing module 312 to assist in producing the navigational output 314. For example, the inertial aiding module 316 may include various sensors, such as one or more accelerometers or gyroscopes, for example, and associated circuitry. The navigation subsystem may output steering vectors that are used by the electronic protection subsystem 302 to point the scanning beam 118 and/or point one or more other antennas in the antenna module 308.

The electronic support subsystem 306 is configured to perform various functionality and processing associated with the anti-jam capabilities of the anti-jam receiver 300, as well as bistatic radar processing according to techniques disclosed herein. The spatial processing implemented for anti-jamming may also supply information used by the electronic support subsystem 306 for capabilities such as jamming signal direction finding, characterization, and geolocation. The electronic support subsystem 306 includes a direction finding circuit 318, a jammer isolation module 320, and a jammer characterization module 322, all of which are present in existing anti-jam receivers, and are leveraged, according to examples disclosed herein, to add bistatic radar capability to the anti-jam receiver 300.

According to certain examples, the direction finding circuit 318 reports angle of arrival information for the jamming signals 122. This information provides the unit vector u in FIG. 2. In examples, because the jamming signals 122 are above the noise floor, specialized correlators are not required to detect the jamming signal 122, as in the case of GNSS-based bistatic radar described above. In contrast, collection of time domain samples of the jamming signals 122 and reflections 124 using capability present in the anti-jam receiver 300 for anti-jamming also provides the information used for bistatic radar processing.

Using the angle of arrival information provided by the direction finding circuit 318, the jammer isolation module 320 may spatially isolate one or more jamming signals 122 for further characterization (e.g., determination of one or more jamming signal parameters by the jammer characterization module 322). The isolated jamming signal 122 can then also be used in the bistatic radar processing. In some examples, spatial isolation of the jamming signals may be accomplished using antenna beamforming applied to one or more antennas in the antenna module 308. As described above, in certain examples, spatial adaptive processing can be applied to control the antenna beamforming. For example, space-time adaptive processing (STAP) can be used to control the beamforming to allow a high-powered jamming signal 122 through in a desired direction (the direction being determined based on the angle of arrival information provided by the direction finding circuit 318) while adaptively nulling the jamming signal 122 in other directions. STAP, space-frequency adaptive processing (SFAP), or other spatial adaptive processing can be applied in both the direct and reflected channels 112, 114. In some examples, the spatial adaptive processing can be used to provide steering gain towards the target 130. Since the unit vector in the direction of the target 130 is known from the pointing angle of the scanning beam 118, this information can be used to calculate steering vectors (FIG. 3) for the target 130. Thus, the signal power in the desired direction can be increased. In addition, by the controlling the shape of the antenna pattern, significant attenuation can be achieved in other directions.

Still referring to FIG. 3, the jammer isolation module 320 may thus provide the two channel outputs used for bistatic radar processing, namely direct beam(s) 324 (corresponding to the direct jamming signal(s) 122) and scan beam(s) 326 (corresponding to the reflection(s) 124 from the target 130). The direct beam(s) 324 and scan beam(s) 326 are provided from the jammer isolation module 320 to beam correlation processing circuit 328. Data from the time-aligned direct and reflected channels is cross correlated to find the difference in time/distance between the two signal paths. The difference in the correlation peaks provides m, which as noted in Equation (4) above, corresponds to a+r in FIG. 2. The unit vector d is known as it is the antenna pointing angle of the antenna in the antenna module 308 that produces the scanning beam 118 scanning the area for the reflections 124. Based on this information, range calculations can be performed by a range calculator 330, according to the Equations discussed above to acquire an estimate of the range, r. to the target 130 and then the position of the target relative to the anti-jam receiver 300.

Thus, in examples, the anti-jam receiver 300 can acquire and process the jamming signal(s) 122 and reflection(s) 124 applying normal anti-jam processing and using existing anti-jam hardware to provide the information that can then also be used for bistatic radar processing. The beam correlation processing circuit 328, along with the range calculator 330, can be added to the electronic support subsystem 306 via software and/or firmware. In some examples, the direction finding circuit 318, the beam correlation processing circuit 328, and the range calculator 330 together provide a bistatic radar signal processing subsystem 336. As discussed above, the jamming signals 122 are generally significantly higher power than the GNSS signals they are intended to defeat. In some examples, the anti-jam receiver 300 may be capable of mitigation of jamming signals 122 that are up to 120 dB higher signal power than the GNSS signal power. For example, the anti-jam receiver 300 may be able to process jamming signals 122 that are in a range of approximately 80-120 dB higher in signal power than the GNSS signal power. The higher power associated with the jamming signals may significantly extend the range and radar cross section capabilities of a bistatic radar system implemented with the anti-jam receiver 300 according to the techniques and examples disclosed herein.

In some examples, bistatic radar based on the jamming signals 122 and their reflections 124 as described above can be used in conjunction with standard GNSS based bistatic radar. For example, the GNSS signals acquired by the GNSS processing module 312 can also be used for bistatic radar processing to produce additional estimates of the target range(s) r.

The concept of bistatic passive ranging can be extended to synthetic aperture radar (SAR). SAR is used to image an area by utilizing a small antenna and forming a large synthetic aperture as opposed to utilizing a large antenna. In the case of bistatic radar, there is no transmitted power used, and therefore imaging can be performed without disclosing the location of the receiver, which may be advantageous in several applications. According to certain examples, SAR processing circuit 332 can be implemented in the electronic support subsystem 306, optionally using software, firmware, or a combination of both. Information from the beam correlation processing circuit 328 and the range calculator 330 can be provided to the SAR processing circuit 332, as shown in FIG. 3. Motion of the anti-jam receiver 300, or motion of the jamming sources 120, generates the azimuth information used for imaging without requiring a narrow beamwidth antenna. The SAR processing circuit 332 may produce image output 334. Thus, in some examples, the SAR processing circuit 332 may also form part of the bistatic radar signal processing subsystem 336 described above.

### Methodology

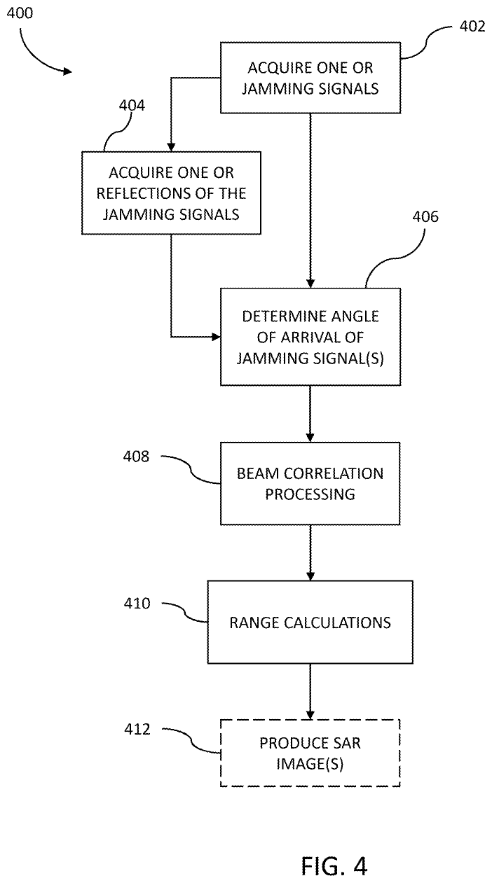

Referring to FIG. 4, there is depicted a process flow diagram of an example of a method signal processing 400, including bistatic radar processing using jamming signals, in accord with certain examples.

At operation 402, one or more jamming signals 122 emitted by jammer(s) 120 are acquired by the bistatic radar receiver, which as discussed above, may be implemented using the anti-jam receiver 300. Accordingly, in some examples, the one or more jamming signals 122 are acquired using the antenna module 308. As described above, spatial adaptive processing may be used to control beamforming of the antenna to spatially isolate the one or more jamming signals 122 and may optionally provide steering vectors to point the antenna in the direction of the corresponding source 120.

At operation 404, the scanning beam is pointed/scanned over an area to acquire at least one reflection 124 of the jamming signal(s) 122 from the target 130. As described above, in certain examples, the scanning beam corresponds to the reception pattern of one of the antennas in the antenna module 308. Spatial adaptive processing may be used to provide steering vectors to steer the scanning beam 118 and/or to control a shape of the scanning beam 118. It will be appreciated that operations 402 and 404 may be repeated, continuously or periodically, and may be performed substantially simultaneously.

At operation 406, an angle of arrival of the jamming signal(s) 122 is determined. As described in above, in certain examples, determining the angle of arrival information may be accomplished by the direction finding circuit 318 of the anti-jam receiver 300.

At operation 408, beam correlation processing software and/or circuitry, such as the beam correlation processing circuit 328 of the anti-jam receiver 300, for example, may be used to determine a correlation between a peak of the jamming signal(s) and a corresponding peak of the reflection(s) 124.

Operation 410 includes deriving a range, r, to the target 130 based on the angle of arrival of the jamming signal 122, the correlation, and a pointing angle of the scanning beam 118. In examples, the range, r, to the target can be determined using the Equations and process described above with reference to FIG. 2. According to certain examples, the range calculations can be performed by the range calculator 330 of the anti-jam receiver 300.

Thus, the jamming signals 122 can be used to operate a bistatic radar and passively determine the range to one or more targets 130. As described above, in certain examples, the bistatic radar is implemented in anti-jam receiver, such as the anti-jam receiver 300. Accordingly, in some examples, the anti-jam receiver 300 can perform all anti-jamming, navigation, and/or other processing in conjunction with implementing examples of the method 400.

As also described, in some examples where there is relative motion between the receiver 110 and the source(s) 120, the beam correlation information determined at operation 408 and the range information determined at operation 410 can be used for SAR processing. Accordingly, in some examples, operation 412 includes producing one or more SAR images based on the correlation information, the determined range to the target 130, and relative movement between the jammer (e.g., source 120) and the anti-jam receiver 300. Example Computing Platform

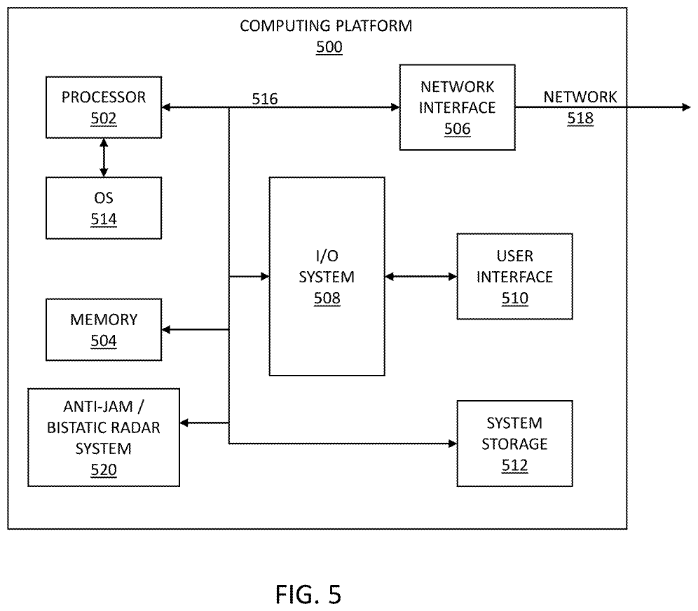

FIG. 5 illustrates an example computing platform 500 that can be used to implement components and/or functionality of the anti-jam receiver 300 described herein. In some embodiments, computing platform 500 may host, or otherwise be incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, imaging device, wearable device, embedded system, and so forth. Any combination of different devices may be used in certain embodiments. In some embodiments, the computing platform 500 represents one system in a network of systems coupled together via controlled area network (CAN) bus or other network bus.

In some examples, the computing platform 500 may comprise any combination of a processor 502, a memory 504, an embodiment of an anti-jam/bistatic radar system 520 (such as at least some components and/or functionality of the anti-jam receiver 300), a network interface 506, an input/output (I/O) system 508, a user interface 510, and a storage system 512. In some embodiments, one or more components of the anti-jam receiver 300 (e.g., the at least some functionality of one or more of the functional subsystems 302, 304, 306) are implemented as part of the processor 502. As shown in FIG. 5, a bus and/or interconnect 516 is also provided to allow for communication between the various components listed above and/or other components not shown. The computing platform 500 can be coupled to a network 518 through the network interface 506 to allow for communications with other computing devices, platforms, or resources. Other componentry and functionality not reflected in the block diagram of FIG. 5 will be apparent in light of this disclosure, and it will be appreciated that other embodiments are not limited to any particular hardware configuration.

The processor 502 can be any suitable processor and may include one or more coprocessors or controllers to assist in control and processing operations associated with the computing platform 500. In some embodiments, the processor 502 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core.

The memory 504 can be implemented using any suitable type of digital storage including, for example, flash memory and/or random access memory (RAM). In some embodiments, the memory 504 may include various layers of memory hierarchy and/or memory caches as are known to those of skill in the art. The memory 504 may be implemented as a volatile memory device such as, but not limited to, a RAM, dynamic RAM (DRAM), or static RAM (SRAM) device. The storage system 512 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, the storage system 512 may comprise technology to increase the storage performance enhanced protection for valuable digital media when multiple hard drives are included.

The processor 502 may be configured to execute an Operating System (OS) 514 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with the computing platform 500, and therefore may also be implemented using any suitable existing or subsequently-developed platform.

The network interface 506 can be any appropriate network chip or chipset which allows for wired and/or wireless connection between other components of the computing platform 500 and/or the network 518, thereby enabling the computing platform 500 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

The I/O system 508 may be configured to interface between various I/O devices and other components of the computing platform 500. I/O devices may include, but not be limited to, a user interface 510. The user interface 510 may include devices (not shown) such as a display element, touchpad, keyboard, mouse, and speaker, etc. The I/O system 508 may include a graphics subsystem configured to perform processing of images for rendering on a display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into the processor 502 or any chipset of the computing platform 500. In some examples, the I/O system 508 may display the image output from the SAR processing circuit 332 to a user. The I/O system 508 may also display other information, such as the target range(s) r, navigational information that may be part of the navigational output 314, jammer information that may be part of jammer reports output by the jammer characterization module 322, etc.

It will be appreciated that in some embodiments, the various components of the computing platform 500 may be combined or integrated in a system-on-a-chip (SoC) architecture. In some embodiments, the components may be hardware components, firmware components, software components or any suitable combination of hardware, firmware, or software, so as to provide a functional component (e.g., instructions encoded in a processor memory or in a machine-readable medium, gate-level logic or purpose-built semiconductor).

In various embodiments, the computing platform 500 may be implemented as a wireless system, a wired system, or a combination of both. When implemented as a wireless system, the computing platform 500 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, the computing platform 500 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. Thus, in some examples, the circuit or circuitry may include one or more processors in combination with instructions to be executed by the one or more processors. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Various embodiments of the components and/or modules described herein may be functionally implemented using one or more hardware elements, and possibly one or more software elements. Accordingly, the term “module” as used in any embodiment herein, may comprise, for example, singly or in any combination, one or more hardware elements and, optionally, one or more software elements that together implement the functionality described with respect to the module.

Examples of hardware elements may include processors, microprocessors, microcontroller units (MCUs), controllers, circuits, circuit elements (for example, transistors, resistors, capacitors, inductors, resonant structures, and so forth), integrated circuits, ASICs, programmable logic devices, digital signal processors, FPGAs, GPUs, logic gates, registers, semiconductor devices, chips, microchips, chipsets, non-transitory computer-readable or machine-readable media encoded with instructions, and so forth. Examples of software may include software components, programs, applications, computer programs, application programs, system programs, machine programs, operating system software, middleware, software routines, subroutines, functions, methods, procedures, software interfaces, application program interfaces, instruction sets, computing code, computer code, code segments, computer code segments, words, values, symbols, or any combination thereof. Further, some embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

### Additional Examples

Example 1 is a bistatic radar receiver comprising at least one first antenna configured to receive one or more jamming signals, a second antenna configured to point a scanning beam to detect one or more reflections of the one or more jamming signals from a target, and a signal processing subsystem coupled to the at least one first antenna and to the second antenna, the signal processing subsystem configured to process the one or more jamming signals and the one or more reflections to derive a range to the target from the one or more jamming signals and the one or more reflections.

Example 2 includes the bistatic radar receiver of Example 1, wherein the signal processing subsystem comprises a direction finding circuit configured to provide angle of arrival data for the one or more jamming signals.

Example 3 includes the bistatic radar receiver of Example 2, wherein the signal processing subsystem further comprises a range calculator configured to derive the range to the target from the one or more jamming signals and the one or more reflections using the angle of arrival data and a pointing angle of the second antenna.

Example 4 includes the bistatic radar receiver of any one of Examples 1-3, wherein the bistatic radar receiver is an anti-jam receiver.

Example 5 includes the bistatic radar receiver of Example 4, wherein the anti-jam receiver comprises a navigation module, and anti-jam circuitry configured to filter the one or more jamming signals to mitigate an effect of the one or more jamming signals on the navigation module.

Example 6 includes the bistatic radar receiver of any one of Examples 1-5, wherein one or both of the at least one first antenna or the second antenna is a controlled reception pattern antenna.

Example 7 includes the bistatic radar receiver of Example 6, wherein the signal processing subsystem is configured to apply spatial adaptive processing to control a shape of an antenna pattern of the at least one first antenna.

Example 8 includes the bistatic radar receiver of any one of Examples 1-7, wherein to derive the range to the target, the signal processing subsystem comprises a beam correlation processing circuit configured to determine a correlation between a peak of the one or more jamming signals and a corresponding peak of the one or more reflections.

Example 9 includes the bistatic radar receiver of Example 8, wherein the signal processing subsystem further comprises a synthetic aperture radar circuit configured to produce a synthetic aperture radar image based on relative movement between the bistatic radar receiver and a source of the one or more jamming signals, the correlation, and the range to the target.

Example 10 provides a bistatic radar method comprising acquiring at least one jamming signal emitted by a jammer, pointing a scanning beam to acquire at least one reflection of the jamming signal from a target, determining an angle of arrival of the jamming signal, determining a correlation between a peak of the at least one jamming signal and a corresponding peak of the at least one reflection, and deriving a range to the target based on the angle of arrival of the jamming signal, the correlation, and a pointing angle of the scanning beam.

Example 11 includes the method of Example 10, wherein acquiring the at least one jamming signal includes acquiring the at least one jamming signal with an anti-jam receiver.

Example 12 includes the method of Example 11, further comprising producing a synthetic aperture radar image based on the correlation, the range, and relative movement between the jammer and the anti-jam receiver.

Example 13 includes the method of any one of Examples 10-12, further comprising controlling a shape of the scanning beam using spatial adaptive processing.

Example 14 provides a bistatic radar system configured to implement the method of any one of Examples 10-13.

Example 15 provides an anti-jam receiver configured to implement the method of any one of Examples 10-13.

Example 16 is passive ranging apparatus comprising a first antenna configured to receive a jamming signal emitted by a jammer, a second antenna configured to point a scanning beam, at least one processor, and at least one tangible non-transitory computer-readable storage medium storing program instructions that when executed by the at least one processor configure the passive ranging apparatus to point the scanning beam to acquire a reflection of the jamming signal from a target, determine an angle of arrival of the jamming signal at the first antenna, and derive a range to the target based on the jamming signal, the reflection, the angle of arrival, and a pointing angle of the scanning beam.

Example 17 includes the passive ranging apparatus of Example 16, wherein the at least one tangible non-transitory computer-readable storage medium further stores program instructions that when executed by the at least one processor configure the passive ranging apparatus to determine a correlation between a peak of the jamming signal and a corresponding peak of the reflection.

Example 18 includes the passive ranging apparatus of Example 17, wherein at least one tangible non-transitory computer-readable storage medium storing program instructions that when executed by the at least one processor configure the passive ranging apparatus to produce a synthetic aperture radar image based on the correlation, the range, and relative motion between the passive ranging apparatus and the jammer.

Example 19 includes the passive ranging apparatus of any one of Examples 16-18, wherein the first antenna is a controlled reception pattern antenna.

Example 20 includes the passive ranging apparatus of Example 19, wherein the at least one tangible non-transitory computer-readable storage medium further stores program instructions that when executed by the at least one processor configure the passive ranging apparatus to control a shape of an antenna pattern of the first antenna using spatial adaptive processing.

Example 21 includes the passive ranging apparatus of any one of Examples 16-20, wherein the passive ranging apparatus is implemented in an anti-jam receiver.

Example 22 includes the passive ranging apparatus of Example 21, wherein the anti-jam receiver comprises a navigation module, and anti-jam circuitry configured to filter the jamming signal to mitigate an effect of the jamming signal on the navigation module.

Having described above several aspects of at least one embodiment, it is to be appreciated various alterations, modifications, and improvements will readily occur to those skilled in the art. Such alterations, modifications, and improvements are intended to be part of this disclosure. Accordingly, the foregoing description and drawings of various embodiments are presented by way of example only. These examples are not intended to be exhaustive or to limit embodiments to the precise forms disclosed. The methods and apparatuses are capable of implementation in other embodiments and of being practiced or of being carried out in various ways. In addition, the phraseology and terminology used herein is for the purpose of description and should not be regarded as limiting. Any references to examples, components, elements, or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including”, “comprising”, “having”, “containing”, “involving”, and variations thereof is meant to encompass the items listed thereafter and equivalents thereof as well as additional items. References to “or” can be construed as inclusive so that any terms described using “or” can indicate any of a single, more than one, and all of the described terms.

What is claimed is:

1. A bistatic radar receiver comprising:
at least one first antenna configured to receive one or more jamming signals;
a second antenna configured to point a scanning beam to detect one or more reflections of the one or more jamming signals from a target; and
a signal processing subsystem coupled to the at least one first antenna and to the second antenna, the signal processing subsystem configured to process the one or more jamming signals and the one or more reflections to derive a range to the target from the one or more jamming signals and the one or more reflections.

2. The bistatic radar receiver of claim 1, wherein the signal processing subsystem comprises a direction finding circuit configured to provide angle of arrival data for the one or more jamming signals.

3. The bistatic radar receiver of claim 2, wherein the signal processing subsystem further comprises a range calculator configured to derive the range to the target from the one or more jamming signals and the one or more reflections using the angle of arrival data and a pointing angle of the second antenna.

4. The bistatic radar receiver of claim 1, wherein the bistatic radar receiver is an anti-jam receiver.

5. The bistatic radar receiver of claim 4, wherein the anti-jam receiver comprises:
a navigation module; and
anti-jam circuitry configured to filter the one or more jamming signals to mitigate an effect of the one or more jamming signals on the navigation module.

6. The bistatic radar receiver of claim 1, wherein the at least one first antenna is a controlled reception pattern antenna.

7. The bistatic radar receiver of claim 1, wherein the second antenna is a controlled reception pattern antenna.

8. The bistatic radar receiver of claim 1, wherein to derive the range to the target, the signal processing subsystem comprises a beam correlation processing circuit configured to determine a correlation between a peak of the one or more jamming signals and a corresponding peak of the one or more reflections.

9. The bistatic radar receiver of claim 8, wherein the signal processing subsystem further comprises a synthetic aperture radar circuit configured to produce a synthetic aperture radar image based on relative movement between the bistatic radar receiver and a source of the one or more jamming signals, the correlation, and the range to the target.

10. A bistatic radar method comprising:
acquiring at least one jamming signal emitted by a jammer;
pointing a scanning beam to acquire at least one reflection of the jamming signal from a target;
determining an angle of arrival of the jamming signal;
determining a correlation between a peak of the at least one jamming signal and a corresponding peak of the at least one reflection; and
deriving a range to the target based on the angle of arrival of the jamming signal, the correlation, and a pointing angle of the scanning beam.

11. The method of claim 10, wherein acquiring the at least one jamming signal includes acquiring the at least one jamming signal with an anti-jam receiver.

12. The method of claim 11, further comprising:
producing a synthetic aperture radar image based on the correlation, the range, and relative movement between the jammer and the anti-jam receiver.

13. The method of claim 10, further comprising:
controlling a shape of the scanning beam using spatial adaptive processing.

14. A passive ranging apparatus comprising:
a first antenna configured to receive a jamming signal emitted by a jammer;
a second antenna configured to point a scanning beam;
at least one processor; and
at least one tangible non-transitory computer-readable storage medium storing program instructions that when executed by the at least one processor configure the passive ranging apparatus to
point the scanning beam to acquire a reflection of the jamming signal from a target,
determine an angle of arrival of the jamming signal at the first antenna, and
derive a range to the target based on the jamming signal, the reflection, the angle of arrival, and a pointing angle of the scanning beam.

15. The passive ranging apparatus of claim 14, wherein the at least one tangible non-transitory computer-readable storage medium further stores program instructions that when executed by the at least one processor configure the passive ranging apparatus to:
determine a correlation between a peak of the jamming signal and a corresponding peak of the reflection.

16. The passive ranging apparatus of claim 15, wherein at least one tangible non-transitory computer-readable storage medium storing program instructions that when executed by the at least one processor configure the passive ranging apparatus to:
produce a synthetic aperture radar image based on the correlation, the range, and relative motion between the passive ranging apparatus and the jammer.

17. The passive ranging apparatus of claim 14, wherein the first antenna is a controlled reception pattern antenna.

18. The passive ranging apparatus of claim 17, wherein the at least one tangible non-transitory computer-readable storage medium further stores program instructions that when executed by the at least one processor configure the passive ranging apparatus to:
control a shape of an antenna pattern of the first antenna using spatial adaptive processing.

19. The passive ranging apparatus of claim 14, wherein the passive ranging apparatus is implemented in an anti-jam receiver.

20. The passive ranging apparatus of claim 19, wherein the anti-jam receiver comprises:
a navigation module; and
anti-jam circuitry configured to filter the jamming signal to mitigate an effect of the jamming signal on the navigation module.
